(19) United States
(12) Patent Application Publication
(10) Pub. No.: US 2024/0149726 A1
(43) Pub. Date: May 9, 2024

(54) ARTICULATING ROOF ASSEMBLIES FOR ELECTRICAL GENERATORS AND VEHICLE CHARGING STATIONS

(71) Applicant: GM GLOBAL TECHNOLOGY OPERATIONS LLC, Detroit, MI (US)

(72) Inventors: Alan B. Martin, Washington, MI (US); Tom Jay Jerome, Clarkston, MI (US); Thomas Chrostowski, Sterling Heights, MI (US); Zhun Liu, Columbus, IN (US)

(73) Assignee: GM GLOBAL TECHNOLOGY OPERATIONS LLC, Detroit, MI (US)

(21) Appl. No.: 17/983,515

(22) Filed: Nov. 9, 2022

(51) Int. Cl. B60L 53/57; B60L 53/18; B60L 53/51; B60L 53/54; B60L 53/60; B62D 63/08; E05D 15/06; H01M 8/04014; H01M 8/04082; H01M 8/04858; H01M 8/2465; H01M 10/44; H01M 14/00; H01M 16/00; H02J 7/14; H02J 7/35

(52) U.S. Cl. CPC B60L 53/57; B60L 53/18; B60L 53/51; B60L 53/54; B60L 53/60; B62D 63/08; E05D 15/0621; H01M 8/04014; H01M 8/04201; H01M 8/0494; H01M 8/2465; H01M 10/441; H01M 14/00; H01M 16/003; H02J 7/14; H02J 7/35; E05Y 2201/684; E05Y 2900/542; H01M 2220/20; H01M 2250/20

(57) ABSTRACT

Presented are articulating roof assemblies for electrical generator systems, methods for making/using such roof assemblies, and fuel cell powered electric vehicle charging stations with such roof assemblies. An electrical generator system includes a mobile or stationary rigid support frame with an electrical generator that is mounted to the support frame and operable to generate electric power. At least one charging cable is electrically connected to the generator in order to transfer the electric power to a load. A control circuit is communicatively connected to the generator and governs the creation and transfer of electric power. Mounted onto the rigid support frame is a roof assembly with one or more roof panels. Each roof panel is movable between an undeployed position, whereat the roof panel at least partially covers the generator, and a deployed position, whereat the roof panel is obliquely angled to and/or projects outwardly from the rigid support frame.

### INTRODUCTION

The present disclosure relates generally to electrical generators for converting mechanical or chemical energy into electric power. More specifically, aspects of this disclosure relate to fuel cell powered electrical generators and vehicle charging stations.

Current production motor vehicles, such as the modern-day automobile, are originally equipped with a powertrain that operates to propel the vehicle and power the vehicle's onboard electronics. In automotive applications, for example, the vehicle powertrain is generally typified by a prime mover that delivers driving torque through an automatic or manually shifted power transmission to the vehicle's final drive system (e.g., differential, axle shafts, corner modules, road wheels, etc.). Automobiles have historically been powered by a reciprocating-piston type internal combustion engine (ICE) assembly due to its ready availability and relatively inexpensive cost, light weight, and overall efficiency. Such engines include compression-ignited (CI) diesel engines, spark-ignited (SI) gasoline engines, two, four, and six-stroke architectures, and rotary engines, as some non-limiting examples. Hybrid-electric and full-electric vehicles (collectively “electric-drive vehicles”), on the other hand, utilize alternative power sources to propel the vehicle and, thus, minimize or eliminate reliance on a fossil-fuel based engine for tractive power.

A full-electric vehicle (FEV)—colloquially labeled an “electric car”—is a type of electric-drive vehicle configuration that altogether omits an internal combustion engine and attendant peripheral components from the powertrain system, relying instead on a rechargeable energy storage system (RESS) and a traction motor for vehicle propulsion. The engine assembly, fuel supply system, and exhaust system of an ICE-based vehicle are replaced with a single or multiple traction motors, a traction battery pack, and battery cooling and charging hardware in a battery-based FEV. Hybrid-electric vehicle (HEV) powertrains, in contrast, employ multiple sources of tractive power to propel the vehicle, most commonly operating an internal combustion engine in conjunction with a battery-powered or fuel-cell-powered traction motor. Since hybrid-type, electric-drive vehicles are able to derive their power from sources other than the engine, HEV engines may be turned off, in whole or in part, while the vehicle is propelled by the electric motor(s).

High-voltage (HV) electrical systems govern the transfer of electricity between the traction motors and the rechargeable battery packs that supply the requisite power for operating many hybrid-electric and full-electric powertrains. To provide the power capacity and energy density needed to propel a vehicle at desired speeds and ranges, contemporary traction battery packs group multiple battery cells (e.g., 8-16+ cells/stack) into individual battery modules (e.g., 10-40+ modules/pack) that are electrically interconnected and mounted onto the vehicle chassis, e.g., by a battery pack housing or support tray. Located on a battery side of the HV electrical system is a front-end DC-to-DC power converter that is electrically connected to the traction battery pack(s) in order to increase the supply of voltage to a main DC bus and a DC-to-AC power inverter module (PIM). A high-frequency bulk capacitor may be arranged across the positive and negative terminals of the main DC bus to provide electrical stability and store supplemental electrical energy. A dedicated Electronic Battery Control Module (EBCM), through collaborative operation with a Powertrain Control Module (PCM) and each motor's power electronics package, governs operation of the battery pack(s) and traction motor(s).

As hybrid and electric vehicles become more prevalent, infrastructure is being developed and deployed to make day-to-day use of such vehicles feasible and convenient. Electric vehicle supply equipment (EVSE) for recharging electric-drive vehicles comes in many form factors, including residential electric vehicle charging stations (EVCS) that are purchased and operated by a vehicle owner (e.g., installed in the owner's garage). Other EVSE examples include publicly accessible EVCS made available by public utilities or private retailers (e.g., at municipal charging facilities or commercial charging stations), and advanced high-powered, high-voltage charging stations used by manufacturers, dealers, and service stations. Plug-in hybrid and electric vehicles, for instance, can be recharged by physically connecting a charging cable of the EVCS to a complementary charging port of the vehicle. By comparison, wireless charging systems utilize electromagnetic field (EMF) induction or other wireless power transfer (WPT) technology to provide vehicle charging capabilities without the need for charging cables and cable ports. It is axiomatic that large-scale vehicle electrification in turn necessitates a concomitant buildout of readily accessible charging infrastructure that can support daily vehicle use in both urban and rural scenarios, for both short-distance and long-distance vehicle ranges.

### SUMMARY

Presented herein are articulating roof assemblies for electrical generator systems, methods for making and methods for using such roof assemblies, and fuel cell powered generators/charging stations with such roof assemblies. In a non-limiting example, there are presented mobile FC-powered EVCS for recharging the traction battery packs of electric-drive vehicles. The mobile EVCS includes a wheeled trailer that carries a high-voltage DC fuel cell (FC) generator, an FCS fuel supply system for storing and dispensing a hydrogen-rich fuel, one or more plug-in cables for electrically connecting the generator to electric loads, and electrical conditioning, cooling, and control hardware for governing the transfer of electricity. Extending across the top of the mobile EVCS is an articulating roof assembly with a pair of roof panels that covers the fuel cell generator and attendant electrical hardware for added protection during EVCS transport and storage. When desired, one or both roof panels may be deployed outwardly from opposing sides of the trailer to provide an awning for shielding users of the mobile EVCS from sun, rain, and other inclement weather. The plug-in cables may be suspended from the roof panels to provide cable lift assist to users of the EVCS and to preclude cable damage by preventing the cables from being dropped on the ground. For a hybrid FCS-photovoltaic EVCS architecture, a solar panel may be buttressed on each roof panel; the roof panels may be actively deployed to optimized tilt angles that will maximize PV output. To improve thermal management of the EVCS's heat-generating components, the roof panels may be actively deployed to an optimized airflow routing orientation for increased convective cooling by ambient airflow.

Attendant benefits for at least some of the disclosed concepts include articulating roof assemblies for mobile or stationary electrical generator systems that help to protect the system during transit/idle and provide weather protection to users of the generator system. The roof assembly may be scaled up or down (e.g., include a single or multiple roof panels) and may be readily adapted for different applications (e.g., each panel may slide and/or rotate to various positions). To prevent cable damage/wear, a roof panel may be designed to support one or more of the plug-in charging cables. The roof may also support solar panels that capture solar energy to supplement the system's electrical capacity. The roof panels may provide active thermal management to route system exhaust in line with passing airflow to achieve a scavenging effect for better system efficiency.

Aspects of this disclosure are directed to articulating roof assemblies for electrical generator systems, including standalone and grid-integrated designs for both automotive and non-automotive applications. In an example, there is presented an electrical generator system for generating electrical power for an electric load. The generator system includes a mobile or stationary support frame with an electrical generator that is mounted onto the rigid support frame and operable to selectively generate electric power. One or more charging cables are electrically connected to the generator in order to transfer the electric power from the generator to one or more loads, such as an electric-drive vehicle. An electronic control circuit is communicatively connected to the electrical generator and operable to govern the system's creation and transfer of electric power. A roof assembly is mounted onto the support frame and includes one or more roof panels. Each roof panel is movable between an undeployed position, whereat the roof panel at least partially covers the generator, and a deployed position, whereat the roof panel is obliquely angled to and/or projects outwardly from a lateral side or fore/aft end of the support frame.

Additional aspects of this disclosure are directed to FC-powered vehicle charging stations for recharging the batteries of motor vehicles. As used herein, the terms “vehicle” and “motor vehicle” may be used interchangeably and synonymously to include any relevant vehicle platform, such as passenger vehicles (ICE, REV, FEV, fully and partially autonomous, etc.), commercial vehicles, industrial vehicles, tracked vehicles, off-road and all-terrain vehicles (ATV), motorcycles, farm equipment, watercraft, aircraft, etc. For non-automotive applications, disclosed concepts may be implemented for all logically relevant uses, including stand-alone power stations, portable power packs, backup generator systems, pumping equipment, residential, commercial and industrial uses, etc. By way of non-limiting example, a mobile EVCS is presented for recharging traction battery packs of electric-drive vehicles. The mobile EVCS is equipped with a rigid support frame, which may be in the nature of a towable, wheeled trailer with housing sidewalls that project upwardly from the wheeled trailer and collectively define a protective outer housing. One or more fuel storage containers are mounted onto the rigid support frame to store a hydrogen-rich fuel (e.g., pure or mixed H₂) and, if desired, an oxygen rich fuel (e.g., pure or mixed O₂). An electrical generator is mounted to the EVCS support frame, e.g., within the charger housing, and operable to generate electric power. The generator may be in the nature of a fuel cell system with one or more fuel cell stacks that are fluidly connected to the fuel storage container(s) and operable to convert the fuel into electricity.

Continuing with the discussion of the preceding example, one or more charging cables are electrically connected to the electrical generator; each charging cable includes an insulated, high-voltage electrical cable with a plug-in connector (e.g., CHAdeMO, CCS, etc.) that is connectable to compatible connector ports of the electric-drive vehicle(s). An electronic control circuit is communicatively connected to the generator and attendant electronic hardware to govern the creation and transfer of system-generated power. A roof assembly is mounted onto the support frame, extending across an opening at the top of the system outer housing. The roof assembly includes a pair of automated roof panels, each of which is movable between a respective undeployed position, whereat the roof panel at least partially covers the electrical generator, and a respective deployed position, whereat the roof panel is obliquely angled to and/or projects outwardly from the rigid support frame.

Aspects of this disclosure are also directed to manufacturing workflow processes, system control logic, and computer-readable media (CRM) for making and/or using any of the disclosed roof assemblies and/or generator systems. In an example, a method is presented for manufacturing an electrical generator system. This representative method includes, in any order and in any combination with any of the above and below disclosed options and features: receiving a rigid support frame; mounting an electrical generator to the rigid support frame, the electrical generator being operable to generate electric power; connecting a charging cable to the electrical generator, the charging cable being configured to transfer the electric power generated by the electrical generator to a load; connecting a control circuit to the electrical generator, the control circuit being configured to govern the creation and transfer of electric power; and mounting a roof assembly to the rigid support frame, the roof assembly including a roof panel movable between an undeployed position, whereat the roof panel at least partially covers the electrical generator, and a deployed position, whereat the roof panel is obliquely angled to and/or projecting outwardly from the rigid support frame.

For any of the disclosed systems, methods, and devices, the roof assembly may employ a single roof panel or multiple (first, second, third, etc.) roof panels, each of which may be moved manually or via controller-automated actuator from a respective undeployed position, at least partially covering a respective surface area of the generator system, and a respective deployed position, angled to and/or projecting outwardly from a respective side/end of the generator's support frame. In either instance, the roof assembly may use a respective slide rail assembly to slidably mount each roof panel to the support frame such that the roof panel slides back-and-forth between its undeployed and deployed positions. As another option, the roof assembly may use a respective pivot hinge assembly to pivotably mount each roof panel to the support frame such that the roof panel rotates back-and-forth between its undeployed and deployed positions. An electromechanical, hydraulic, or pneumatic actuator may be employed to deploy/retract the roof panel(s).

For any of the disclosed systems, methods, and devices, the roof assembly may employ a cable coupling assembly to mount a charging cable to a roof panel such that the charging cable moves in unison with the roof panel from the undeployed position to the deployed position, and back again. In this instance, the cable coupling assembly may include a cable suspension bracket that suspends the charging cable from an underside surface of the roof panel, e.g., to enable connecting of the cable to an electric load while preventing the cable from touching the ground. As yet another option, a protective cable cabinet may be fixedly mounted onto the generator's rigid support frame; the cable coupling assembly may employ a spring-driven cable retractor that biases the charging cable from an extended state, extending out from the cable cabinet, to a retracted state, retracted into the cable cabinet.

For any of the disclosed systems, methods, and devices, a photovoltaic (PV) cell may be mounted onto an exterior surface of a roof panel in order to produce additional electric power for the electrical generator system. In this instance, the cell-bearing roof panel may be deployed to any one of multiple tilt angles at which the roof panel and the PV cell are obliquely angled to the rigid support frame, e.g., to optimize PV energy production. As another option, a roof panel may be deployed to any one of multiple predefined venting positions displaced away from and obliquely angled to the rigid support frame such that the panel routes ambient airflow across the generator and/or electrical hardware to thereby convectively remove thermal energy therefrom. For multi-panel constructions, each roof panel may be independently deployed to a distinct length/angle from the support frame.

For any of the disclosed systems, methods, and devices, the rigid support frame may include a towable, wheeled trailer with multiple housing sidewalls that project upwardly from the wheeled trailer and interconnect with one another to form a lockable and weatherproof generator housing. The roof assembly may extend across and cover a roof opening between the sidewalls. For a closed-shell construction without a roof opening, the deployable roof panels may sit flush within complementary recesses in a roof panel of the generator housing. The electrical generator may take on a variety of different forms, including FC-powered generators, PV-powered generators, engine-powered generators, grid-integrated generators, and any combination thereof. For EVCS applications, the charging cable may include an electrical cable with a plug-in connector that is connectable to a compatible connector port of an electric-drive vehicle.

The above Summary does not represent every embodiment or every aspect of the present disclosure. Rather, the foregoing summary merely provides a synopsis of some of the novel concepts and features set forth herein. The above features and advantages, and other features and attendant advantages of this disclosure, will be readily apparent from the following Detailed Description of illustrated examples and representative modes for carrying out the disclosure when taken in connection with the accompanying drawings and appended claims. Moreover, this disclosure expressly includes any and all combinations and subcombinations of the elements and features presented above and below.

### BRIEF DESCRIPTION OF THE DRAWINGS

FIG. 1 is an elevated, plan-view illustration of a representative grid-integrated, stationary electrical generator system with a single-panel deployable roof assembly in accordance with aspects of the present disclosure.

FIG. 2 is a schematic illustration of a representative fuel cell (FC) powered electrical generator that may be implemented by the electrical generator system of FIG. 1 in accordance with aspects of the present disclosure.

FIG. 3 is a front, perspective-view illustration of a representative mobile, FC-powered standalone electric vehicle charging station (EVCS) with a multi-panel deployable roof assembly in accordance with aspects of the present disclosure.

FIG. 4 is a rear, perspective-view illustration of the representative FC-powered mobile EVCS of FIG. 3 shown with the roof panels each bearing a solar-powered photovoltaic (PV) cell and both deployed to the same optimized tilt angle.

FIG. 5 is another rear, perspective-view illustration of the representative FC-powered mobile EVCS of FIG. 3 shown with one of the roof panels deployed to an optimized airflow routing orientation for increased convective cooling by ambient airflow.

The present disclosure is amenable to various modifications and alternative forms, and some representative embodiments of the disclosure are shown by way of example in the drawings and will be described in detail herein. It should be understood, however, that the novel aspects of this disclosure are not limited to the particular forms illustrated in the above-enumerated drawings. Rather, this disclosure covers all modifications, equivalents, combinations, permutations, groupings, and alternatives falling within the scope of this disclosure as encompassed, for example, by the appended claims.

### DETAILED DESCRIPTION

This disclosure is susceptible of embodiment in many different forms. Representative embodiments of the disclosure are shown in the drawings and will herein be described in detail with the understanding that these embodiments are provided as an exemplification of the disclosed principles, not limitations of the broad aspects of the disclosure. To that extent, elements and limitations that are described, for example, in the Abstract, Introduction, Summary, and Detailed Description sections, but not explicitly set forth in the claims, should not be incorporated into the claims, singly or collectively, by implication, inference or otherwise.

For purposes of the present detailed description, unless specifically disclaimed: the singular includes the plural and vice versa; the words “and” and “or” shall be both conjunctive and disjunctive; the words “any” and “all” shall both mean “any and all”; and the words “including,” “containing,” “comprising,” “having,” and the like, shall each mean “including without limitation.” Moreover, words of approximation, such as “about,” “almost,” “substantially,” “generally,” “approximately,” and the like, may each be used herein in the sense of “at, near, or nearly at,” or “within 0-5% of,” or “within acceptable manufacturing tolerances,” or any logical combination thereof, for example. Lastly, directional adjectives and adverbs, such as fore, aft, inboard, outboard, starboard, port, vertical, horizontal, upward, downward, front, back, left, right, etc., may be with respect to a motor vehicle, such as a forward driving direction of a motor vehicle when the vehicle is operatively oriented on a horizontal driving surface.

Discussed below are electrical generator systems, such as stationary, mobile, standalone, and grid-integrated generator systems, equipped with a multifunctional articulating roof assembly. By way of example, and not limitation, a fuel cell (FC) powered mobile charging station is equipped with a single-panel or multi-panel articulating roof that is designed to provide user protection from rain, sun, snow, and other elements. For PV-powered architectures, the roof assembly is designed to collect solar energy by means of a photovoltaic (PV) cell array. To that end, each roof panel may buttress thereon a solar-powered PV cell and may be deployable to any one of multiple optimized tilt angles for maximum PV power production. A roof panel may suspend therefrom one or more of the charging cables to assist users with operating the heavy charging cables while also helping to preclude wear and damage by preventing the cable and connector from being dropped on the ground. Additionally, one or more of the roof panels may be selectively deployed to an optimized airflow routing orientation to help direct ambient airflow across the heat-generating electrical components of the generator system.

According to aspects of the disclosed concepts, an electrical generator system includes an electrochemical fuel cell stack that converts hydrogen-based fuel into electricity, a control system for monitoring and operating the fuel cell stack, a thermal management system for regulating the operating temperature of the stack and its peripheral hardware, and a weatherproof enclosure for protecting the generator system. The electrical generator system also includes an articulating roof that is moved manually or by electronic actuators that are activated/deactivated by the control system to shield nearby users from sun, rain, snow, etc. A plug-in charging cable may be suspended from a deployable roof panel to facilitate mating of the charging cable with a complementary charger port. The suspension attachment point traverses between a stowed location, near or inside the system's protective enclosure, and a deployed location, spaced from the protective enclosure and proximal to an electric load. The cable suspension assembly may employ a dedicated actuator to pay out and/or retract the charging cable using a recoil spring, a motorized spool, a counterweight system, or a similarly applicable technology.

The articulating roof assembly may be deployed and retracted manually, e.g., via pull-handle and slide rail system, hand-cranked gear box and control arms, etc. or via controller-activated actuators, e.g., bidirectional motor, air cylinder, hydraulic piston, etc. For PV-powered generator systems, the control system may track anticipated solar coverage during the day and actively modulate the roof panel tilt angle to maximize collection of solar energy. In a similar regard, the control system may track nearby wind currents and actively modulate the generator, the roof panel's airflow routing orientation, and the system's cooling fan airflow to route system exhaust in concert with ambient crosscurrents. This may involve movement of the roof panels to direct radiator outlet flow and air currents together, and may employ louvers on the roof panels that can be fixed or adjustable to blend together the two airflow paths.

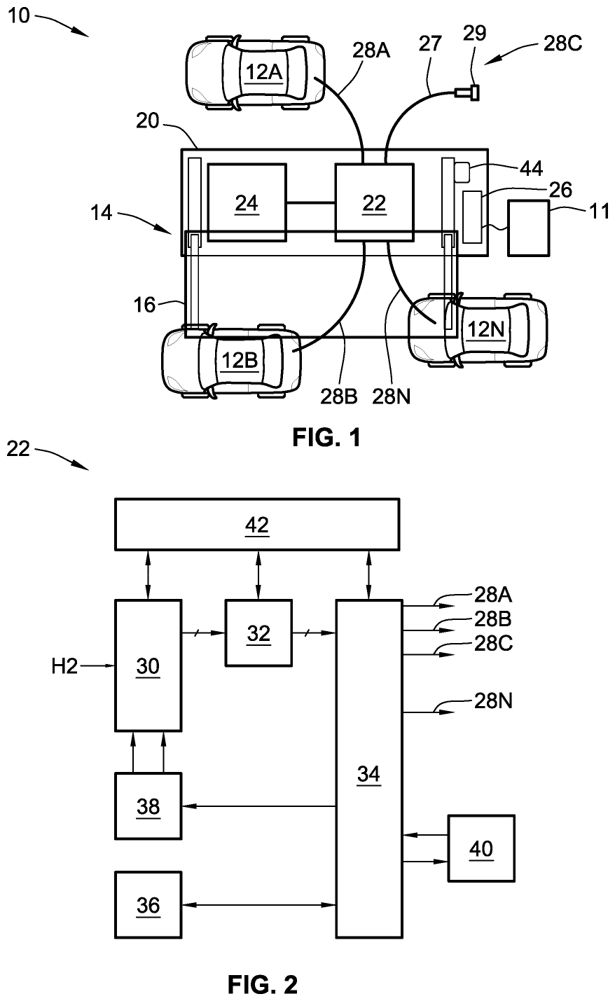

Referring now to the drawings, wherein like reference numbers refer to like features throughout the several views, there is shown in FIG. 1 a representative electrical generator system for producing electrical power for an electric load, which is portrayed herein for purposes of discussion as a grid-integrated, stationary EVCS 10 for recharging multiple electric-drive automobiles 12A, 12B, . . . 12N. It will be appreciated that the EVCS 10 of FIG. 1 is merely an example of an application with which novel aspects of this disclosure may be practiced. In the same vein, the illustrated automobiles 12A-12N—also referred to herein as “motor vehicle” or “vehicle” for short—are merely exemplary electric loads provided for purposes of explaining novel aspects of this disclosure. As such, it will be understood that facets and features of this disclosure may be incorporated into any logically relevant type of electrical generator system, may be utilized for charging or powering an assortment of different electric loads, and may be implemented for automotive and non-automotive applications alike. Moreover, only select components of the electrical generator systems and articulating roof assemblies are shown and described in additional detail herein. Nevertheless, the generator systems and roof assemblies discussed below may include numerous additional and alternative features, and other available peripheral components, for carrying out the various methods and functions of this disclosure.

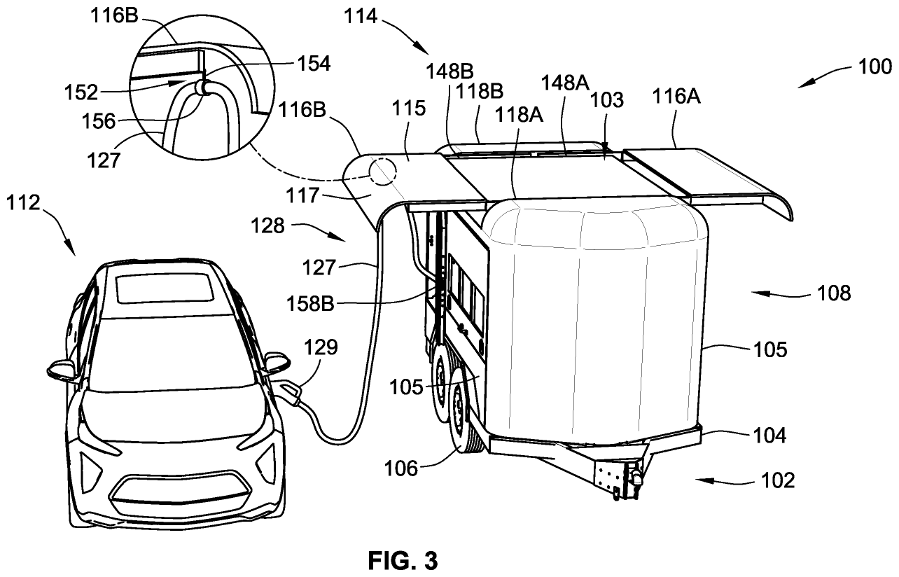

Presented in FIG. 1 is a plan-view illustration of a grid-integrated, stationary electrical generator system 10 with a single-panel deployable roof assembly 14. The electrical generator system 10 may be characterized as “stationary” in that it is erected as a permanent fixture and, thus, is not designed to be readily transported. Likewise, the generator system 10 may be characterized as “grid-integrated” in that it is equipped with the requisite electrical connectors and hardware to draw power from and, if desired, deliver power to an electric grid system (e.g., a publicly accessible electric utility company). Antithetically, FIGS. 3-5 present a mobile, standalone electric vehicle charging station (EVCS) 100 with a multi-panel deployable roof assembly 114. The mobile EVCS 100 may be characterized as “mobile” in that it is equipped with features to be readily transported and, thus, is not designed to be a permanent fixture. Moreover, the mobile EVCS 100 may be characterized as “standalone” in that it is constructed to produce electrical power independently of an external power source and, thus, lacks the cabling, inverter, rectifier, etc., needed to convert the alternating current (AC) of a public utility into direct current (DC). Although differing in appearance, it is envisioned that any of the features and options described with reference to the generator system 10 of FIG. 1 may be incorporated, singly or in any combination, into the EVCS 100 of FIG. 3, and vice versa.

The electrical generator system 10 of FIG. 1 includes a rigid support frame in the form of an elevated support platform 20 that buttresses an industrial power generator 22, a generator fuel supply 24, a grid-tie power unit 26, and multiple connector cables 28A, 28B, 28C . . . 28N. The grid-tie power unit 26 may contain an AC-to-DC power inverter, a DC ground fault interrupter, a main service disconnect switch, a main line cable and connector, and/or any other integration hardware needed to electrically couple the electrical generator system 10 to a two-way AC utility meter 11. The connector cables 28A-28N each electrically couples a respective load, such as an electric-drive vehicle 12A-12N, to the generator system 10 to enable the exchange of electricity. Each connector cable 28A-28N may include an insulated, high-voltage electrical cable 27 with a plug-in connector 29 (e.g., CHAdeMO, CCS Type 1 or Type 2, GB/T, etc.) that is connectable to compatible connector ports of the electric-drive vehicle(s) 12A-12N. While shown with four cables connected to three loads, the electrical generator system 10 may include any number and type of electrical connectors to power/charge and number and type of electric loads.

Power generator 22 of FIG. 1 may take on a variety of different forms, including a FC-powered generator, a PV-powered generator, an engine-powered generator, and any combination thereof. As shown, the power generator 22 may be a 240-480 volts direct current (Vdc) diesel or gas-powered generator adapted as a Level 2 or Level 3 direct-current fast charging (DCFC) EVCS. Alternatively, the power generator 22 may be adapted as a fuel cell powered generator employing a high-voltage, high-capacity fuel cell system, as will be described in further detail below and with respect to the mobile EVCS 100 of FIG. 3. The generator 22 is generally operable to convert chemical energy, solar energy, etc., into electrical power that can be used to selectively power, charge, recharge, or discharge (e.g., V2G exchange) a load. In various embodiments, the generator 22 may implement one or more fuel cell stacks that may be operated individually and collectively with one another, e.g., to accommodate periods of high-demand and low-demand energy consumption. For engine-powered configurations, the generator fuel supply 24 may employ a fuel tank for storing and supplying gasoline, diesel, natural gas, etc. For FC-powered configurations, the fuel supply 24 may employ a fuel container for storing and supplying a hydrogen fuel (e.g., a liquid hydrogen storage tank, a compressed hydrogen gas storage tank, a metal hydride solid hydrogen storage tank, etc.).

With continuing reference to FIG. 1, each vehicle 12A-12N may be in the nature of a battery electric vehicle (BEV), a plug-in hybrid electric vehicle (HEV), or other related electric-drive vehicle form factor. To that end, each electric-drive vehicle 12A-12N may be equipped with an onboard high-voltage traction battery pack that powers one or more electric traction motors to propel the vehicle. A vehicle 12A-12N—be it FEV, REV, FCEV, or ICE—may be originally equipped with a low-voltage (LV) starting, lighting, and ignition (SLI) battery that may be used, for example, to power vehicle accessories and equipment, such as radios, fans, lights, instrument panels, and the like. The cables cable 28A-28N may be operational to carry LV or HV electrical power from the generator 22 to the vehicles 12A-12N to slowly or rapidly charge the SLI batteries or traction battery packs, respectively. Other voltage ranges and charging speeds may be implemented to meet the design criteria of a particular application. If desired, the high-voltage and low-voltage power output may be used to power other devices of a particular application, such as industrial pumping, manufacturing, or construction equipment.

Presented in FIG. 2 is a schematic diagram of the electrical power generator 22 of FIG. 1 embodied as a fuel cell powered generator unit. The power generator 22 of FIG. 2 may be generally typified by a fuel cell system 30, a DC boost converter circuit 32, a switch circuit 34, a rechargeable energy storage system (RESS) 36, a fuel cell plant circuit 38, a portable inverter 40, and an electronic controller 42. Each connector cables 28A-28N may be electrically connected at one end thereof to the switch circuit 34 of the power generator 22. In this example, stored fuel (e.g., H2) from the fuel supply 24 (FIG. 1) may be injected into the individual fuel cell stacks in the fuel cell system 30. A stack output signal may be transmitted from the fuel cell system 30 to the DC boost converter circuit 32 indicating the electrical power generated by stacks in the fuel cell system 30. A recharge signal may be transmitted from the DC boost converter circuit 32 to the switch circuit 34 to indicate the electrical power generated by the fuel cell system 30. In turn, the switch circuit 34 may transmit branches of the recharge signal to thereby transfer branches of the DC electrical power through the cables 28A-28N to their respective plug-in connectors 29.

A fuel cell control signal may be exchanged between the electronic controller 42 and the fuel cell system 30 to transfer control signals and operational information between the controller 42 to the stack 30. Similar control signals and information may be exchanged between the controller 42 and the DC boost converter circuit 32, the switch circuit 34, the RESS 36, and any of the other illustrated electrical hardware components. The fuel cell system 30 may employ one or more fuel cell stacks to generate electrical power from hydrogen-rich fuel and an oxidizing agent. The stack-generated electrical power may be presented in a stack output signal to the DC boost converter circuit 32, e.g., in a range of approximately 275 Vdc to approximately 400 Vdc from approximately 100 kilowatts to approximately 750 kilowatts. The DC boost converter circuit 32 may implement one or more DC-to-DC boost converters to convert the voltage range of the stack output into a recharge signal with a voltage range suitable to recharge the requesting electric load.

The switch circuit 34 may implement high-voltage switching circuitry to route (or switch) some or all of the recharge signal to the charging cables 28A-28N, the portable inverter 40, the fuel cell plant circuit 38, or the RESS 36. The rechargeable energy storage system 36 may implement one or more electrical energy storage devices, such as high-voltage, lithium-class secondary batteries, to selectively store and dispense electrical energy received from the DC boost converter circuit 32. The fuel cell plant circuit 38 may implement a variety of electrical, pneumatic, and thermal devices that support operations of the fuel cell stacks within the fuel cell system 30. The portable inverter 40 may implement a DC-to-DC converter and/or a DC-to-AC converter to convert a high-voltage signal to a low-voltage signal (e.g., in a range of about 10 Vdc to 15 Vdc or in a range of about 110 Vac to 130 Vac). The electronic controller 42 may implement control logic and/or software to govern the overall operation of the generator 22.

With reference next to FIG. 3, there is shown another representative example of an electrical generator system, this time in the form of a standalone, mobile FC-powered EVCS 100 with a multi-panel articulating roof assembly 114. In this instance, the mobile EVCS 100 is transportable on a towable cargo trailer 102 with a dual-axle “tandem” trailer frame 104 and two sets of road wheels 106 rotatably coupled to the trailer frame 104. Mounted onto the trailer frame 104 is a protective EVCS outer housing 108 that may be in the nature of an enclosed, watertight and lockable cargo box. The EVCS outer housing 108 may be erected from adjoining and interconnected housing sidewalls 105, each of which may comprise a prefinished aluminum panel that projects vertically upwards from the wheeled trailer 102. The articulating roof assembly 114 extends across a roof opening 103 located between the upper ends of the housing sidewalls 105. It should be appreciated that the shape, size and material composition of the cargo trailer 102 and EVCS housing 108 may be varied to accommodate other intended applications.

As noted above, the EVCS 100 of FIG. 3 may include any of features and options described with reference to the generator system 10 of FIG. 1 and power generator 22 of FIG. 2, and vice versa. While not visible in the views provided, the EVCS housing 108 may contain one or more electrical generators (e.g., power generator 22) and one or more fuel storage containers (e.g., generator fuel supply 24), both of which may be mounted onto the rigid trailer frame 104. A plug-in charging cable 128 is electrically coupled to the electrical generator(s) in order to transfer generator-produced electric power to a connected load, such as electric-drive vehicle 112. Similar to the connector cables 28A-28N of FIG. 1, the plug-in charging cable 128 of FIG. 3 includes an insulated HV electrical cable 127 with a standardized DC plug-in connector 129 that mates with a compatible connector port of the vehicle 112. A control circuit, which may comprise any or all of the FCS attendant electrical hardware illustrated in FIG. 2, is communicatively connected to the EVCS's resident generator in order to govern the creation and transfer of the electric power by the mobile FC-powered EVCS 100.

Located on top of the EVCS housing 108 and securely mounted to the trailer frame 104 is a roof assembly 114 with either a single deployable roof panel (e.g., manually deployed, forward-projecting roof panel 16 of FIG. 1) or multiple deployable roof panels (e.g., motor-deployed port and starboard-side roof panels 116A and 116B of FIG. 3). For simplicity of design and ease of manufacture, it may be desirable that all of the roof panels 116A, 116B in a multi-panel design be substantially structurally identical. To facilitate an aerodynamic, flush fit interface with contoured fore and aft roof headers 118A and 118B, for example, each roof panel 116A, 116B may have a substantially flat main panel body 115 with an arcuate overhang 117 integral with and projecting transversely from the main panel body 115. Although shown with either a single roof panel or a pair of panels that project horizontally when deployed, disclosed electrical generator systems may include greater than two deployable roof panels and may employ roof panels that project forward or rearward or downward from the roof portion of the EVCS housing 108.

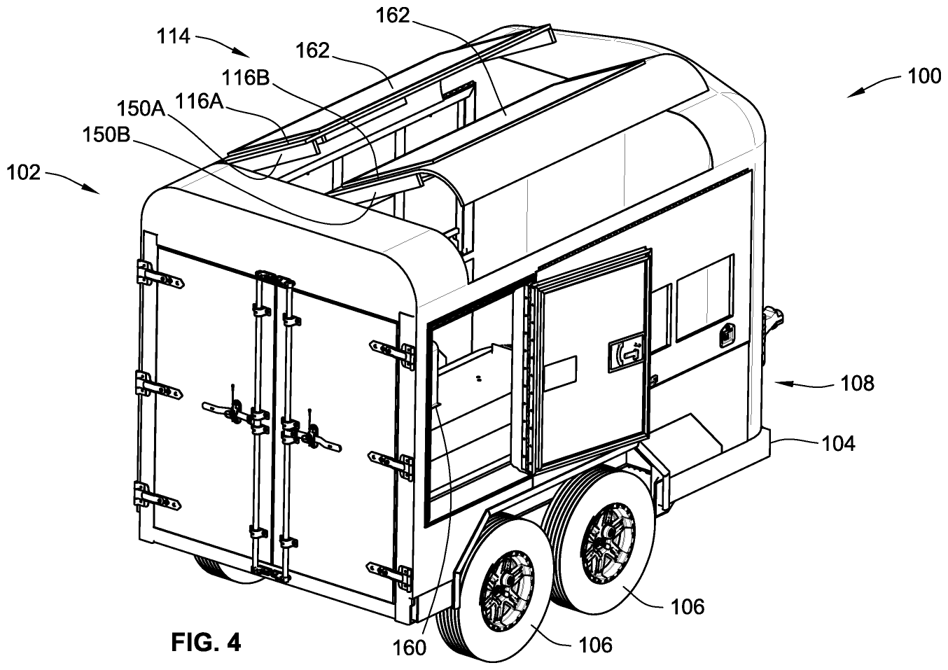

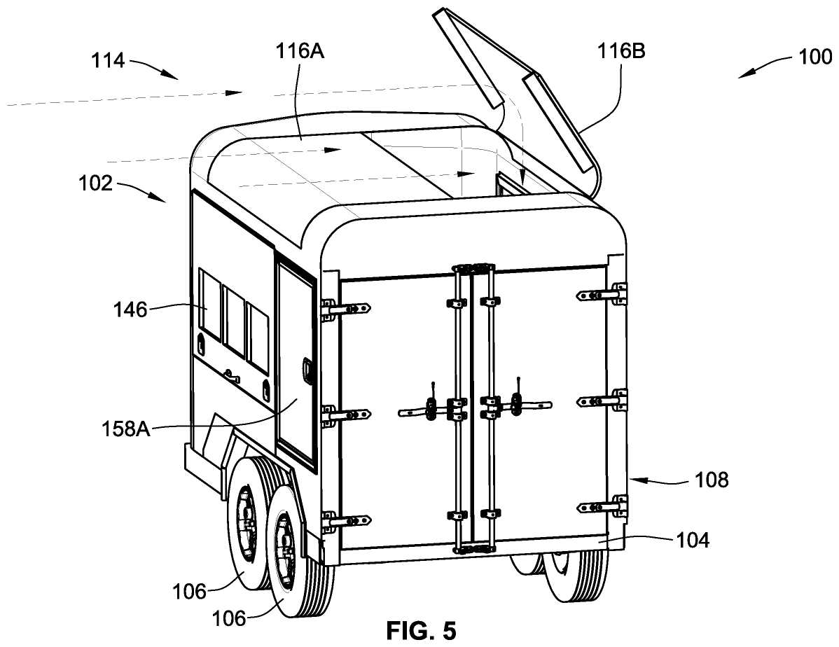

In FIG. 1, the movable roof panel 16 slides rectilinearly back-and-forth between an undeployed position, whereat the roof panel 16 is disposed directly over the support platform 20 and covers both the power generator 22 and fuel supply 24, and a deployed position, whereat the roof panel 16 projects horizontally outward from a front side of the generator's support platform 20. In this example, a user manually operates a hand-cranked gear box 44 to selectively deploy and retract the roof panel 16. As another option, the movable roof panels 116A, 116B of FIG. 3 slide rectilinearly back-and-forth between respective undeployed positions (e.g., FIG. 5), whereat each panel 116A, 116B is disposed with the roof opening 103 and covers a respective surface area of the electrical generator and any other underling hardware within the EVCS housing 108, and respective deployed positions, whereat each panel projects horizontally outward from a respective lateral side of the cargo trailer 102. As will be explained below with reference to FIGS. 4 and 5, each roof panel 116A, 116B may also be deployed to any one of a number of different optimal tilt angles or airflow routing orientations that are obliquely angled to the roof portion of the EVCS housing 108. In operating the mobile FC-powered EVCS 100 of FIG. 3, a user interacts with a control panel 146 on the side of the EVCS housing 108 to activate a bidirectional DC electric motor (not shown) to individually or collectively deploy and retract the roof panels 116A, 116B.

With continuing reference to FIG. 3, the mobile EVCS 100 is equipped with panel mounting hardware to movably couple the roof panels 116A, 116B to the cargo trailer 102. For rectilinear translational movement of the roof panels 116A, 116B, the roof assembly 114 may employ a pair of heavy-duty and lockable ball bearing slide rail assemblies 148A and 148B (FIG. 3) that slidably mount the roof panels 116A, 116B, respectively, to the trailer frame 104 on top of the EVCS housing 108 to thereby slide between their undeployed and deployed positions. For curvilinear rotational movement of the roof panels 116A, 116B, the roof assembly 114 may employ a pair of heavy-duty, flush-mount pivot hinge assemblies 150A and 150B (FIG. 4) that pivotably mount the roof panels 116A, 116B, respectively, to the trailer frame 104 on top of the EVCS housing 108 to thereby rotate between their undeployed and deployed positions. It should be appreciated that disclosed generator systems may employ additional and alternative mounting hardware for movably attaching the roof panel(s) to the support frame, such as pneumatic air cylinders, telescoping hydraulic hinges, a hybrid pivot-slide hinge assemblies, etc.

To provide lift assist to users of the mobile EVCS 100 while concomitantly preventing dropping of the off times heavy and expensive charging cables, a cable coupling assembly 152 mounts the plug-in charging cable 128 to the roof panel 116A such that the charging cable 128 and roof panel 116A move as a unit to and from the deployed position. As shown in the inset view of FIG. 3, the cable coupling assembly 152 may include a cable suspension bracket 154 that suspends the HV electrical cable 127 from an underside surface of the roof panel 116A. It may be desirable that a cable cuff 156 located at a bottom end of the cable suspension bracket 154 slidably receives therethrough the electrical cable 127. As another option, port and starboard-side lockable cable cabinets 158A and 158B, respectively, are mounted onto the trailer frame 104 on the right and left flanks of the EVCS housing 108. In this instance, the cable coupling assembly 152 may employ a spring-driven cable retractor 160 that draws the plug-in charging cable 128 from an extended state, whereat the electrical cable 127 extends out from the cable cabinet 158A, 158B, to a retracted state, whereat the electrical cable 127 retracts into the cable cabinet 158A, 158B.

FIG. 4 illustrates an example in which a semiconductor-based photovoltaic (PV) cell 162 is mounted onto an upwardly facing exterior surface of each roof panel 116A, 116B. These PV cells 162 cooperatively define at least a portion of a photochemical solar cell array that is operable to convert solar (light) energy into electrical power. To maximize electrical output of the PV cells 162, the articulated roof panels 116A, 116B of FIG. 4 may be deployed to any one of multiple optimized tilt angles at which the roof panels 116A, 116B and the PV cell 162 are obliquely angled to the cargo trailer 102 in order to directly face the moving sun. As shown, both panels 116A, 116B are positioned at the same tilt angle (e.g., 40 degrees from horizontal) to face in the same direction (e.g., true south). As the sun moves throughout the day, the roof panels' 116A, 116B positions may be modulated to ensure the PV cells 162 continue to face the sun.

FIG. 5 illustrates an example in which one (or both) of the roof panels 116A, 116B is deployed to any one of multiple venting positions that will optimize venting and/or convective cooling of the FCS and attendant hardware inside the cargo trailer 102. As shown, the starboard roof panel 116B is displaced upward from the EVCS housing 108 and obliquely angled to the trailer frame 104. With this arrangement, the deployed roof panel 116B directs ambient airflow (shown with arrows in FIG. 5) across the power generator and other heat-generating electrical components to thereby convectively remove thermal energy therefrom.

Aspects of the present disclosure have been described in detail with reference to the illustrated embodiments; those skilled in the art will recognize, however, that many modifications may be made thereto without departing from the scope of the present disclosure. The present disclosure is not limited to the precise construction and compositions disclosed herein; any and all modifications, changes, and variations apparent from the foregoing descriptions are within the scope of the disclosure as defined by the appended claims. Moreover, the present concepts expressly include any and all combinations and subcombinations of the preceding elements and features.

What is claimed:

1. An electrical generator system, comprising:
a rigid support frame;
an electrical generator mounted to the rigid support frame and operable to generate electric power;
a charging cable electrically connected to the electrical generator and configured to transfer the electric power to a load;
a control circuit communicatively connected to the electrical generator and configured to govern the generation and transfer of the electric power; and
a roof assembly mounted to the rigid support frame and including a roof panel movable between an undeployed position, whereat the roof panel at least partially covers the electrical generator, and a deployed position, whereat the roof panel is obliquely angled to and/or projecting outwardly from the rigid support frame.

2. The electrical generator system of claim 1, wherein the roof panel includes first and second roof panels movable between respective first and second undeployed positions, at least partially covering respective first and second surface areas of the electrical generator, and respective first and second deployed positions, obliquely angled to and/or projecting outwardly from respective first and second sides of the rigid support frame.

3. The electrical generator system of claim 2, wherein the roof assembly includes first and second slide rail assemblies slidably mounting the first and second roof panels, respectively, to the support frame to thereby slide between the respective first and second undeployed and deployed positions.

4. The electrical generator system of claim 2, wherein the roof assembly includes first and second pivot hinge assemblies pivotably mounting the first and second roof panels, respectively, to the support frame to thereby rotate between the respective first and second undeployed and deployed positions.

5. The electrical generator system of claim 1, further comprising a cable coupling assembly mounting the charging cable to the roof panel such that the charging cable moves in unison with the roof panel from the undeployed position to the deployed position.

6. The electrical generator system of claim 5, wherein the cable coupling assembly includes a cable suspension bracket suspending the charging cable from an underside surface of the roof panel.

7. The electrical generator system of claim 6, further comprising a cable cabinet mounted onto the rigid support frame, wherein the cable coupling assembly further includes a spring-driven cable retractor biasing the charging cable from an extended state, whereat the charging cable extends out from the cable cabinet, to a retracted state, whereat the charging cable retracts into the cable cabinet.

8. The electrical generator system of claim 1, further comprising a photovoltaic (PV) cell mounted onto an exterior surface of the roof panel and operable to produce additional electric power, wherein the deployed position includes multiple tilt angles at which the roof panel and the PV cell are obliquely angled to the rigid support frame.

9. The electrical generator system of claim 1, wherein the deployed position includes a predefined venting position displaced away from and obliquely angled to the rigid support frame such that the roof panel directs ambient airflow across the electrical generator to thereby convectively remove thermal energy therefrom.

10. The electrical generator system of claim 1, wherein the rigid support frame includes a wheeled trailer with multiple sidewalls projecting upwardly from the wheeled trailer, and wherein the roof assembly extends across an opening defined between the sidewalls.

11. The electrical generator system of claim 1, wherein the electrical generator includes a fuel cell system with a fuel cell stack operable to convert a hydrogen fuel into electricity.

12. The electrical generator system of claim 1, wherein the charging cable includes an electrical cable with a plug-in connector connectable to a compatible connector port of an electric-drive vehicle.

13. A mobile electric vehicle charging station (EVCS) for recharging a traction battery pack of an electric-drive vehicle, the mobile EVCS comprising:
a rigid support frame including a wheeled trailer with multiple sidewalls projecting upwardly from the wheeled trailer;
a fuel storage container mounted onto the rigid support frame and configured to store a hydrogen fuel;
an electrical generator mounted to the rigid support frame and operable to generate electric power, the electrical generator including a fuel cell system with a fuel cell stack fluidly connected to the fuel storage container and operable to convert the hydrogen fuel into electricity;
a charging cable electrically connected to the electrical generator and including an electrical cable with a plug-in connector connectable to a compatible connector port of the electric-drive vehicle;
a control circuit communicatively connected to the electrical generator and configured to govern the generation and transfer of the electric power; and
a roof assembly mounted to the support frame and extending across an opening defined between the sidewalls, the roof assembly including a pair of roof panels each movable between a respective undeployed position, whereat the roof panel at least partially covers the electrical generator, and a respective deployed position, whereat the roof panel is obliquely angled to and/or projecting outwardly from the rigid support frame.

14. A method of manufacturing an electrical generator system, the method comprising:
receiving a rigid support frame;
mounting an electrical generator to the rigid support frame, the electrical generator being operable to generate electric power;
connecting a charging cable to the electrical generator, the charging cable being configured to transfer the electric power generated by the electrical generator to a load;
connecting a control circuit to the electrical generator, the control circuit being configured to govern the generation and transfer of the electric power; and
mounting a roof assembly to the rigid support frame, the roof assembly including a roof panel movable between an undeployed position, whereat the roof panel at least partially covers the electrical generator, and a deployed position, whereat the roof panel is obliquely angled to and/or projecting outwardly from the rigid support frame.

15. The method of claim 14, wherein the roof panel includes first and second roof panels movable between respective first and second undeployed positions, at least partially covering respective first and second surface areas of the electrical generator, and respective first and second deployed positions, obliquely angled to and/or projecting outwardly from respective first and second sides of the rigid support frame.

16. The method of claim 15, wherein the roof assembly includes:
first and second slide rail assemblies slidably mounting the first and second roof panels, respectively, to the support frame to thereby slide between the respective undeployed and deployed positions; or
first and second pivot hinge assemblies pivotably mounting the first and second roof panels, respectively, to the support frame to thereby rotate between the respective undeployed and deployed positions.

17. The method of claim 14, further comprising mounting the charging cable to the roof panel via a cable coupling assembly such that the charging cable moves in unison with the roof panel from the undeployed position to the deployed position.

18. The method of claim 17, wherein the cable coupling assembly includes a cable suspension bracket suspending the charging cable from an underside surface of the roof panel.

19. The method of claim 18, further comprising mounting a cable cabinet onto the rigid support frame, wherein the cable coupling assembly further includes a spring-driven cable retractor biasing the charging cable from an extended state, whereat the charging cable extends out from the cable cabinet, to a retracted state, whereat the charging cable retracts into the cable cabinet.

20. The method of claim 14, further comprising mounting onto an exterior surface of the roof panel a photovoltaic (PV) cell operable to produce additional electric power, wherein the deployed position includes multiple tilt angles at which the roof panel and the PV cell are obliquely angled to the rigid support frame.
